(19) United States
(12) Patent Application Publication
(10) Pub. No.: US 2002/0106209 A1
(43) Pub. Date: Aug. 8, 2002

(54) Printing paper detection apparatus and printer

(76) Inventors: Minoru Niimura, Tokyo-to (JP); Hirotsuna Miura, Nagano-ken (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 09/968,147

(22) Filed: Sep. 28, 2001

(30) Foreign Application Priority Data
Oct. 5, 2000 (JP) 2000-306143(P)

(51) Int. Cl. G03G 15/00

(52) U.S. Cl. 399/45

(57) ABSTRACT

A printing paper detection apparatus, which may be embodied in a printer, detects a paper feed amount of printing paper by performing an image recognition process on image data for the printing paper. Such a printer is equipped with a print head, a head shift mechanism section, a light emitting section, a paper feed mechanism section, an image sensor section, and a control apparatus. The image recognition process is performed on image data of the printing paper to thereby detect the paper feed amount.

### BACKGROUND OF THE INVENTION

1. Field of the Invention

The present invention relates to a printing paper detection apparatus, a printer embodying such an apparatus, and a printing paper detection method. More particularly, the printing paper detection apparatus and method of this invention uses an imaging element such as an image sensor to detect a paper feed amount or a characteristic of the printing paper.

2. Description of the Related Art

To detect a paper feed amount in a conventional printer a rotary encoder is used. The rotary encoder is in the shape of a circular disk and is attached to one end of a platen such that an axis of the encoder coincides with an axis of the platen. The diameter of the rotary encoder, which is several times larger than that of the platen, is provided in its peripheral area with linear lines marked thereon or slits. Light is irradiated from a light emitting element toward the rotary encoder, and reflected light or passing light received by a light receiving element is used to detect a rotational angle of the rotary encoder and hence a rotational angle of the platen. Based on the rotational angle of the platen, a paper feed amount of the printing paper is detected.

In a conventional printer, printing paper is placed in an exclusive-use cartridge having a size corresponding to the size of the printing paper. The size of the cartridge that is inserted in the printer is detected to thereby detect the size of the printing paper. The direction in which the cartridge is inserted in the printer is also detected to thereby detect the orientation of the printing paper.

Japanese laid-open patent application HEI 8-194783 (hereinafter simply referred to as “Reference 1”) describes an image reading apparatus that reads an image of an original document that is transferred along a predetermined transfer path and also reads the document's bar code.

Japanese laid-open patent application HEI 10-44512 (hereinafter simply referred to as “Reference 2”) describes a printing apparatus that reads a bar code added to a sheet of paper that is introduced in a paper feed path, and decodes the bar code that is read to thereby obtain data for controlling exposure conditions for printing paper.

Japanese laid-open patent application HEI 8-72286 (hereinafter simply referred to as “Reference 3”) describes a printer apparatus that reads marks added to printing paper, and uses light irradiated on and reflected from the printing paper to measure the reflection coefficient of the printing paper to obtain data concerning the printing paper.

However, there are problems with the above-described arrangements. For example, when the paper feed amount is detected using a rotary encoder in a manner described above, the minimum detectable paper feed amount is about 50μm. Accordingly, depending on the paper feed detection accuracy, the printed image quality is limited to such an extent that printing with a higher print quality d cannot be performed.

Also, while a conventional printing paper detection apparatus can detect the size and orientation of printing paper, in an ink jet printer that uses pigment ink characteristics of the printing paper, such as its front or rear surface, type (e.g., paper for pigment ink, normal paper, re-cycled paper, etc.), and consumption expiration, are required to exploit the characteristics of the pigment ink to its maximum extent and hence use it as expected. However, the conventional printing paper detection apparatus cannot detect such characteristics of the printing paper. Therefore, there is a problem in that the user needs to expressly input the characteristics of the printing paper, such as front or rear surface, type, and consumption expiration, to the printer driver. There is a further problem as well. Even when the user expressly informs the printer driver about such characteristics, printing paper may be printed with its front and rear surfaces reversed, or printing paper may be used after its consumption date has expired, so that the desired print quality cannot be obtained.

References 1, 2 and 3 described above also have problems. The image reading apparatus described in Reference 1 is for reading an image of document and bar codes, but the apparatus does not read characteristics of printing paper, which are required for high quality printing.

As for the printing apparatus described in Reference 2, such apparatus reads bar codes added to a sheet of paper introduced in a paper feed path to obtain data for controlling the exposure condition for the printing paper. One way to do so, is to feed a data sheet with a bar code added thereto into the paper feed path, prior to feeding the printing paper, and reads the bar code. However, with this sequence, substantial time is wasted, which is problematical. Alternatively, a bar code needs to be printed on the printing paper. However, when a bar code is added to the front surface of the printing paper, a problem occurs in that the bar code becomes a hindrance to the user who wants to read characters or images printed on the printing paper. When a bar code is added to the rear surface of the printing paper, a problem occurs in that the effective use of the rear surface of the printing paper, such as printing on both surfaces of the printing paper, is hindered.

Regarding the printer apparatus described in Reference 3, such apparatus can read marks added to printing paper, and receive light irradiated on and reflected from the printing paper to measure the reflection coefficient of the printing paper, whereby data concerning the printing paper can be obtained. However, when a mark is added to the front or rear surface of the printing paper, the same problems are encountered as when a bar code is added, as described above with respect to Reference 2. Furthermore, when the reflection coefficient of the printing paper is measured using irradiated and reflected light, an error may occur in the measurement due to interference of ambient light.

### OBJECTS OF THE INVENTION

The present invention has been made in view of the problems described above. It is therefore an object of the present invention to provide a printing paper detection apparatus and printer embodying such an apparatus which performs an image recognition process on image data obtained by photographing an image of the printing paper to obtain characteristics of the printing paper, without adding a user-hindering mark to the printing paper and without preventing the effective use of the rear surface of the printing paper such as double-sided printing, and without interference from ambient light.

### SUMMARY OF THE INVENTION

To solve the problems described above, a printing paper detection apparatus in accordance with the present invention comprises an imaging device that photographs an image of printing paper to generate image data; and a detection device that performs an image recognition process on the generated image data to detect a feed amount for the printing paper or a characteristic of the printing paper.

Here, the apparatus may further be equipped with a light emitting device that irradiates light on the printing paper. Also, the imaging device may be a CMOS image sensor or a CCD image sensor, and the imaging device may photograph a surface configuration or pattern of the printing paper to obtain a reflection coefficient of the printing paper.

Furthermore, the detection device may detect a rear or front surface of the printing paper or the type of the printing paper. To this end, the printing paper may have one or more marks indicating one or more paper characteristics. The added mark(s), which are made by a colorless ink having a reflectivity different from that of the printing paper, may indicate the rear or front surface of the printing paper, its type, or its consumption expiration. One or more of the marks may be a bar code.

The printing paper detection apparatus described above may be conveniently embodied in a printer.

In another aspect, the invention involves a method for detecting a feed amount for the printing paper or a characteristic of the printing paper.

By performing an image recognition process on image data obtained by photographing an image of the printing paper, one or more characteristics of the printing paper can be obtained and the print quality thereby improved, without adding a user-hindering mark to the printing paper, without preventing the effective use of the rear surface of the printing paper, and without interference from outside light.

### BRIEF DESCRIPTION OF THE DRAWINGS

FIG. 1 shows a block diagram of a printer in accordance with one embodiment of the present invention.

FIG. 2 schematically shows a structure of a printer in accordance with one embodiment of the present invention.

FIG. 3 shows one example of printing paper.

FIG. 4 shows a flow chart of a process of the printer in accordance with the present invention.

FIG. 5 shows a flow chart of a process of the printer in accordance with the present invention.

Description of Reference Numbers

| | |
|---|---|
| 10 | Printer |
| 11 | Head |
| 12 | Head shift mechanism section |
| 13 | Light emitting section |
| 20 | Paper feed mechanism section |
| 21 | Paper feed roller |
| 22 | Ultrasonic motor |
| 30 | Image sensor section |
| 32 | Head sensor |
| 40 | Control apparatus |
| 41 | Input/output control section |
| 42 | Output image conversion section |
| 43 | Shift amount detection section |
| 44 | Paper recognition section |
| 45 | Paper characteristic data store section |
| 46 | Paper feed control section |
| 50 | Head control section |
| 51 | Print control section |
| 52 | Head shift control section |
| 60 | Printing paper |
| 61˜64 | Bar codes |
| 70 | Computer |

### DESCRIPTION OF THE PREFERRED EMBODIMENTS

A printing paper detection apparatus and printer in accordance with the present invention are described below with reference to the accompanying drawings.

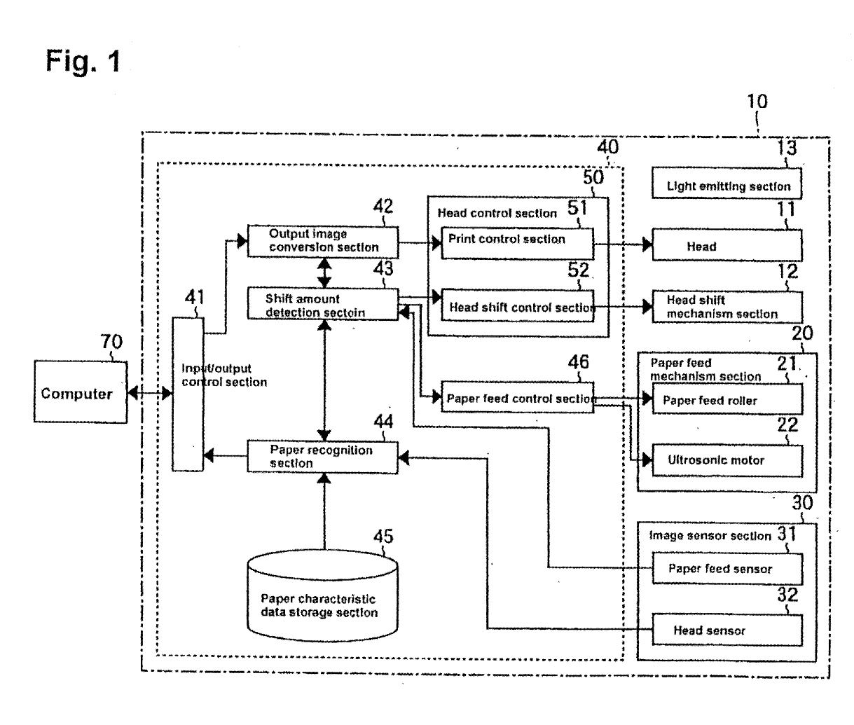

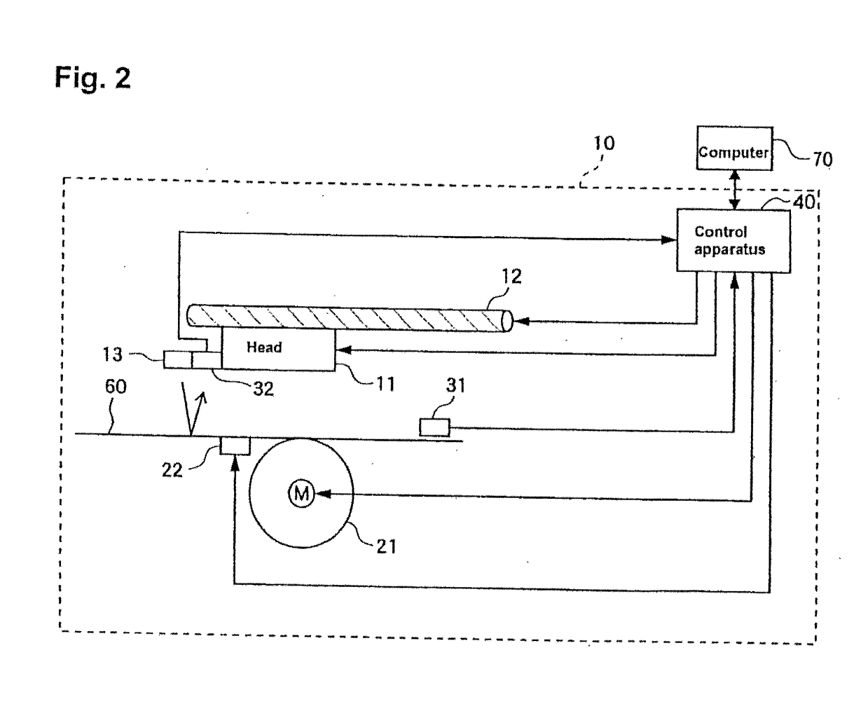

A printer in accordance with a first embodiment is described below with reference to FIGS. 1 and 2. Referring to these figures, a printer 10 is equipped with a head 11 that prints characters or an image on printing paper 60, a head shift mechanism section 12 that moves the head 11 over the printing paper 60, and a light emitting section 13 that is formed from a light emitting diode, a laser diode or the like and that irradiates light on printing paper 60. Printer 10 further includes a paper feed mechanism section 20 equipped with a paper feed roller 21, an ultrasonic motor 22 to transfer printing paper 60, and an image sensor section 30 equipped with a head sensor 32 and a paper feed sensor 31. A control apparatus 40 is embodied in printer 10 and is equipped with an input/output control section 41, an output image conversion section 42, a shift amount detection section 43, a paper recognition section 44, a paper characteristic data storage section 45, a paper feed control section 46, and a head control section 50 which includes a print control section 51 and a head shift control section 52. Printer 10 has a printing paper introduction path, in which printing paper 60 is introduced.

The paper feed sensor 31 and the head sensor 32 may be formed from a CMOS image sensor, a CCD image sensor, or the like. The paper feed sensor 31, which is provided to detect a paper feed amount of printing paper 60, photographs an image of the paper pulp of the printing paper. The head sensor 32 is provided to detect one or more characteristics of printing paper 60, such as its rear or front surface, type (e.g., paper for pigmented ink, normal paper, re-cycled paper, or the like), and consumption expiration. The head sensor 32 does this by reading an image of the paper pulp of printing paper 60 or an image of a mark, such as a bar code, added to the printing paper.

The input/output control section 41 interfaces with a computer 70 to receive print command data and image data of an image to be printed from the computer, and to send data representative of characteristics of printing paper 60 to the computer 70. The output image conversion section 42 receives image data from the input/output control section 41 and converts the received image data to data to be printed by the head 11.

The shift amount detection section 43 receives image data from the paper feed sensor 31 and performs an image recognition process on the received image data to detect a paper feed amount for printing paper 60. Furthermore, the shift amount detection section 43 sends data for the detected paper feed amount to the output image conversion section 42, to the head shift control section 52 and to the paper feed control section 46.

The paper characteristic data storage section 45 stores characteristic data of different kinds of printing paper, such as paper pulp patterns, reflection coefficients, bar codes which identify the rear or front of the printing paper, types of paper, consumption expirations, and the like. The paper recognition section 44 receives image data from the head sensor 32 and performs an image recognition process on the image data, and recognizes the characteristics of printing paper 60 by referring to the corresponding characteristic data retained in the paper characteristic data storage section 45.

The print control section 51 sends print command data and image data of an image to be printed to the head 11. The head shift control section 52 directs the head shift mechanism section 12 to move the head 11 to effect a printing operation.

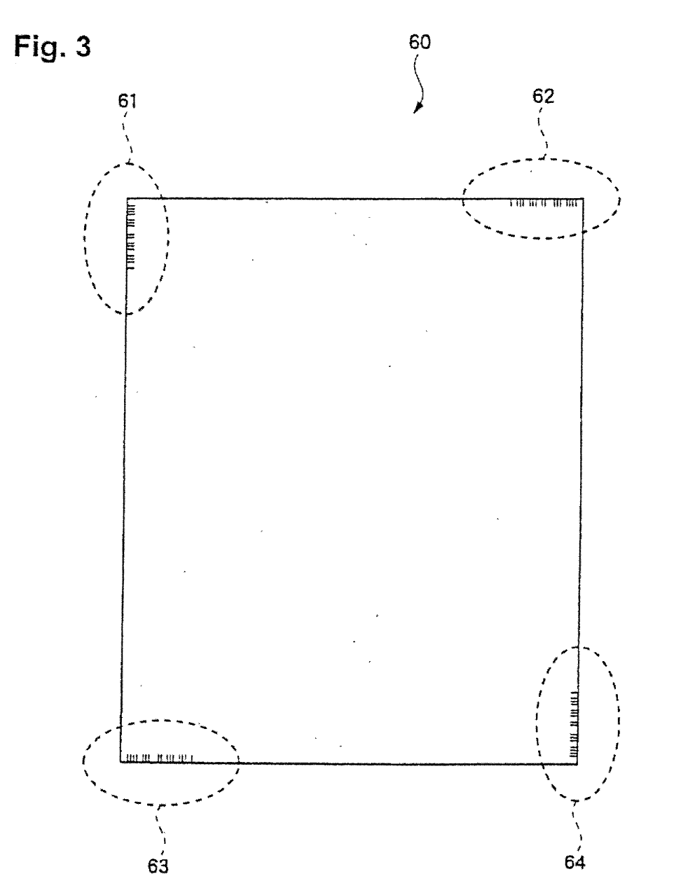

FIG. 3 shows printing paper 60 that is introduced in a path of the printer 10. In FIG. 3, four corners of the printing paper 60 are printed with bar codes, identified by reference numerals 61˜64 respectively, using ink that is colorless and that has a reflectivity different from that of the printing paper.

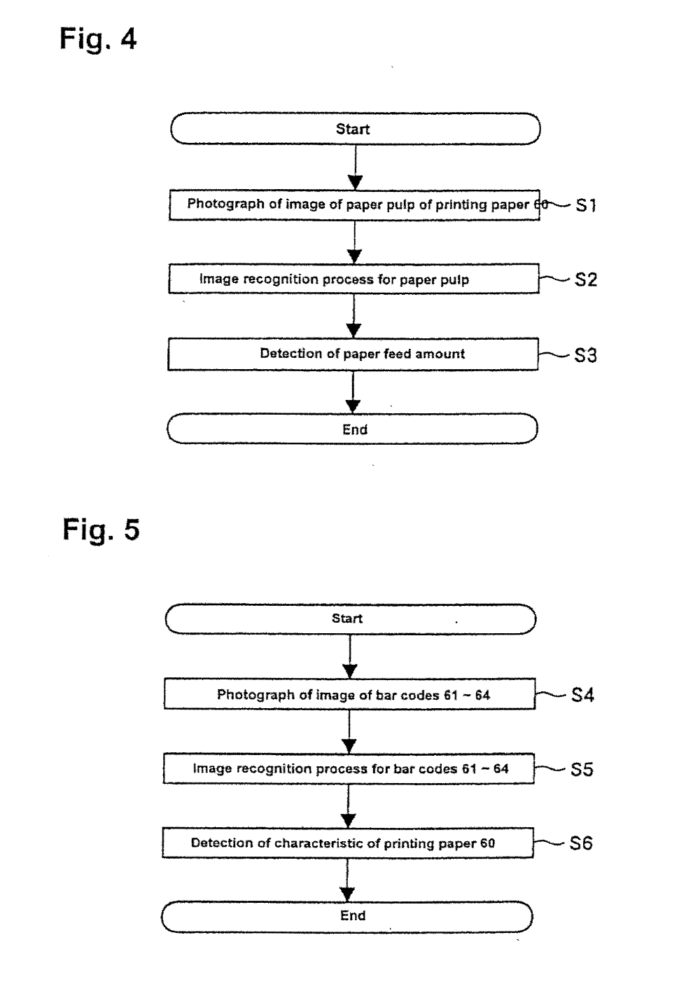

FIG. 4 is a flow chart illustrating a paper feed amount detection process of the printer 10 in accordance with one embodiment of the present invention. Referring to FIG. 4, first the paper feed sensor 31 photographs an image of the paper pulp of printing paper 60 to determine its surface configuration or reflection coefficient and obtains corresponding image data (step S1). Next, the shift amount detection section 43 receives that image data from the paper feed sensor 31 and performs an image recognition process (step S2). In step S3, the shift amount detection section 43 detects a paper feed amount for the printing paper 60 according to the result of the image recognition process in step S2. Also, the paper feed data obtained in this manner can be sent to computer 70 through input/output control section 41.

FIG. 5 is a flow chart illustrating a printing paper characteristic detection process of printer 10 in accordance with the present embodiment. Referring to FIG. 5, first the head sensor 32 photographs an image of the paper pulp of printing paper 60, and an image of the bar codes 60˜64 printed on the printing paper, and obtains respective image data (step S4). The bar codes 61˜64 may include data, such as front or rear surface identifiers, paper type and consumption expiration. Next, the paper recognition section 44 receives that image data from the head sensor 32 and performs an image recognition process on the image data (step S5).

To do this, the paper recognition section 44 compares the image data of the paper pulp and the image data of the bar codes 61˜64 obtained in step S4 to corresponding data stored in the paper characteristic data storage section 45 to detect the front and rear of printing paper 60, its paper type, and its consumption expiration. Also, the characteristic data of printing paper 60 obtained in the manner described above can be sent to the computer 70 through the input/output control section 41.

The mounting direction of printing paper 60 can also be detected with the bar codes 61˜64 printed on the four corners on printing paper 60.

Thus, in the manner described above, by performing an image recognition process on the image data of the paper pulp of printing paper 60 and/or on the image data of the bar codes 61˜64 that are printed on the printing paper 60 with ink that is colorless and has a reflectivity different from that of the paper, characteristics of printing paper 60, such as a paper feed amount, the front and rear of the printing paper and its consumption expiration, can be obtained without adding a user-hindering mark to printing paper 60, without preventing the effective use of the rear surface of the printing paper 60, such as two-surface printing, and without error-causing interference from ambient light.

By way of example only, in order to achieve, say, a 2000 dpi printing resolution in a printer capable of printing such resolution, it is necessary for the printer to detect a paper feed amount on the order of 1/2000 inch. This invention is designed to detect and feed such amount.

As described above, using a printing paper detection apparatus and printer in accordance with the present invention, an image recognition process is performed on image data for printing paper. As a result, characteristics of the printing paper, such as a paper feed amount, the front and rear of the printing paper, and the type and consumption expiration of the printing paper can be detected,. Moreover, the paper feeding can be very accurately performed without adding a user-hindering mark to the printing paper, without preventing the effective use of the rear surface of the printing paper, such as two-surface printing, and without error-causing interference from ambient light.

While the invention has been described in conjunction with several specific embodiments, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

What is claimed is:

1. A printing paper detection apparatus, comprising:
an imaging device that photographs an image of printing paper to generate image data; and
a detection device that performs an image recognition process on the generated image data to detect a feed amount for the printing paper or a characteristic of the printing paper.

2. A printing paper detection apparatus according to claim 1, wherein the imaging device comprises a light emitting device that irradiates light on the printing paper.

3. A printing paper detection apparatus according to claim 1, wherein the imaging device comprises a CMOS image sensor or a CCD image sensor.

4. A printing paper detection apparatus according to claim 1, wherein the imaging device photographs a surface configuration or pattern of the printing paper to obtain a reflection coefficient of the printing paper.

5. A printing paper detection apparatus according to claim 1, wherein the detection device detects at least one of a rear surface, a front surface, or a type of the printing paper.

6. A printing paper detection apparatus according to claim 4, wherein the detection device detects at least one of a rear surface, a front surface, or a type of the printing paper.

7. A printing paper detection apparatus according to claim 1, wherein the printing paper has a mark indicating a paper characteristic, the mark being made by a colorless ink having a reflectivity different from that of the printing paper.

8. A printing paper detection apparatus according to claim 7, wherein the mark added to the printing paper indicates at least one of a rear surface, a front surface, a type, or consumption expiration of the printing paper.

9. A printing paper detection apparatus according to claim 7, wherein the mark added to the printing paper is a bar code.

10. A printing paper detection apparatus according to claim 8, wherein the mark added to the printing paper is a bar code.

11. A printing paper detection method, comprising the steps of:
photographing an image of printing paper to generate image data; and
performing an image recognition process on the generated image data to detect a feed amount for the printing paper or a characteristic of the printing paper.

12. A method according to claim 11, wherein the photographing comprises irradiating light on the printing paper.

13. A method according to claim 11, wherein the photographing is carried out using a CMOS image sensor or a CCD image sensor.

14. A method according to claim 11, wherein the photographing comprises photographing a surface configuration or pattern of the printing paper to obtain a reflection coefficient of the printing paper.

15. A method according to claim 11, wherein the image recognition performing process comprises detecting at least one of a rear surface, a front surface, or a type of the printing paper.

16. A method according to claim 14, wherein the image recognition performing process comprises detecting at least one of a rear surface, a front surface, or a type of the printing paper.

17. A method according to claim 11, wherein the printing paper has a mark indicating a paper characteristic, the mark being made by a colorless ink having a reflectivity different from that of the printing paper.

18. A method according to claim 17, wherein the mark added to the printing paper indicates at least one of a rear surface, a front surface, a type, or consumption expiration of the printing paper.

19. A method according to claim 17, wherein the mark added to the printing paper is a bar code.

20. A method according to claim 18, wherein the mark added to the printing paper is a bar code.

21. A printer, comprising:
printing paper detection apparatus, comprising
an imaging device that photographs an image of printing paper to generate image data; and
a detection device that performs an image recognition process on the generated image data to detect a feed amount for the printing paper or a characteristic of the printing paper.

22. A printer according to claim 21, wherein the imaging device comprises a light emitting device that irradiates light on the printing paper.

23. A printer according to claim 21, wherein the imaging device comprises a CMOS image sensor or a CCD image sensor.

24. A printer according to claim 21, wherein the imaging device photographs a surface configuration or pattern of the printing paper to obtain a reflection coefficient of the printing paper.

25. A printer according to claim 21, wherein the detection device detects at least one of a rear surface, a front surface, or a type of the printing paper.

26. A printer according to claim 24, wherein the detection device detects at least one of a rear surface, a front surface, or a type of the printing paper.

27. A printer according to claim 21, wherein the printing paper has a mark indicating a paper characteristic, the mark being made by a colorless ink having a reflectivity different from that of the printing paper.

28. A printer according to claim 27, wherein the mark added to the printing paper indicates at least one of a rear surface, a front surface, a type, or consumption expiration of the printing paper.

29. A printer according to claim 27, wherein the mark added to the printing paper is a bar code.

30. A printer according to claim 28, wherein the mark added to the printing paper is a bar code.
